(19) United States
(12) Patent Application Publication
(10) Pub. No.: US 2008/0042452 A1
(43) Pub. Date: Feb. 21, 2008

(54) Reversible handing latch bolt for mortise locks

(76) Inventors: Charles W. Moon, Colorado Spring, CO (US); Jan Ryszard Pluto, Reading, PA (US)

Correspondence Address: Richard J. Veltman, Esq.;The Black & Decker Corporation, TW199, 701 East Joppa Road, Towson, MD, 21286, US

(21) Appl. No.: 11/506,745

(22) Filed: Aug. 18, 2006

(51) Int. Cl. E05B 9/00

(52) U.S. Cl. 292/337

(57) ABSTRACT

A reversible latch bolt assembly for a mortise lock. The latch bolt assembly generally comprises a bolt head subassembly having a stem threaded into the rear. The bolt head subassembly engages body designed for anchoring the reversible latch bolt assembly inside a door. The stem is inserted distally into an aperture in the body. A rotary selector assembly is mounted in the body orthogonal to the stem aperture and, when the stem is inserted, selectively engages or disengages the collar of the stem to prevent or allow rotation thereof. The rotary selector assembly is spring biased toward a normally locked position but is rotated to an unlocked position by a hex key or the like. The selector assembly allows free rotation of the bolt head when necessary to reverse the mortise lock, depending on whether the lock is mounted in a left-hand or right-hand door. Since the integral selector assembly is key-operative from the latch body tampering is much more difficult.

### BACKGROUND OF THE INVENTION

1. Field of the Invention

The present invention relates to mortise locks, and more particularly to a reversible latch bolt for a mortise lock that reverses to allow adjustment depending on whether the lock is mounted in a left-hand or right-hand door.

2. Description of the Background

A mortise lock is designed to fit into a mortised recess in the side of a door. When actuated, it extends a latch bolt outward beyond the edge of the door and into a latch plate in the opposing door frame, thereby latching the door in a closed position. Conversely, the latch bolt may be retracted to allow opening of the door.

It is often necessary to reverse the mortise lock depending on whether the lock is mounted in a left-hand or right-hand door. Specifically, a mortise lock mounted in a left-hand door must be rotated 180 degrees for mounting in a right-hand door. Consequently, the latch bolt must also be rotated 180 degrees about a horizontal axis so that the beveled face of the latch faces the door-closing direction. When this is done the indoor and outdoor turn-keys become the outdoor and indoor turn-keys, respectively.

The necessary adjustments to the mortise lock can be accomplished without opening the case. For example, in UK patent application no. GB 2150631 as shown in FIG. 1 the reversible latch bolt comprises a body supporting a removable bolt head on a stem. The stem is formed with a collar, is inserted into the bolt head, and is attached thereto by a compression fitting inserted into the bolt head and abutting the collar of the stem. This allows rotation of the bolt head about an axis parallel to the intended direction of extension and retraction of the bolt. When this reversible latch bolt is mounted on a closure such as a door, the head of the bolt extends through a rectangular aperture provided in a face plate secured to the door. In order to reverse the head of the latch bolt while the lock mechanism is still embedded in the door, it is necessary to remove the face plate, rotate the head, and then replace the face plate.

Unfortunately, the foregoing arrangement can lead to tampering after the lock is installed since the latch bolt can be reversed anytime, even when the mortise lock is in the door, so long as the face plate is removed or altered. It would be more advantageous to provide an reversible latch bolt for a reversible mortise lock that can be selectively set to allow free rotation of the latch bolt, or no rotation, by an integral selector assembly operative from the latch body so that tampering is more difficult. Of course, any such improved latch assembly should be economical to manufacture and use.

### SUMMARY OF THE INVENTION

It is, therefore, the primary object of the present invention to an reversible latch bolt for a reversible mortise lock that can be selectively set to allow free rotation of the latch bolt, or no rotation, without disassembly of the lock components.

It is another object to provide an reversible latch bolt for a reversible mortise lock that operates by an integral selector assembly mounted on the latch body so that tampering is more difficult.

It is still another object to provide an reversible latch bolt for a reversible mortise lock that is economical to manufacture and use.

In accordance with the foregoing objects, the present invention is an reversible latch bolt assembly for a reversible mortise lock. The latch bolt assembly generally comprises a reversible bolt head subassembly which, in the illustrated embodiment, includes a three-prong bolt head formed by a fixed two-prong yoke with trigger-activated single-prong pivotally mounted there between. A stem is threaded into the rear of the fixed two-prong yoke and the stem is formed with an annular collar of semi-circular contour. The bolt head subassembly engages a body designed for anchoring the reversible bolt head subassembly inside a door. Specifically, the stem of the bolt head subassembly is inserted distally into an aperture in the body. A rotary selector assembly is mounted in the body orthogonal to the stem aperture and, when the stem is inserted, selectively engages or disengages the collar of the stem to prevent or allow rotation thereof. The rotary selector assembly is spring biased toward a normally locked position but is rotated 90 degrees to an unlocked position by a hex key or the like. The selector assembly allows free withdrawal and rotation of the bolt head when necessary to reverse the bolt head subassembly, depending on whether the lock is mounted in a left-hand or right-hand door. Since the integral selector assembly is key-operative from the latch body tampering is much more difficult.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a perspective view of a prior art reversible latch bolt from UK patent application no. GB 2150631.

FIG. 2 is an exploded drawing of the major components of the reversible latch bolt for mortise locks according to the present invention.

FIG. 3 is a fully assembled drawing of the reversible latch bolt of FIG. 2.

FIG. 4 is a top view of the fully assembled reversible latch bolt of FIGS. 2-3.

FIG. 5 is a side view of the fully assembled reversible latch bolt of FIGS. 2-4.

FIG. 6 is an exploded perspective drawing of the bolt head subassembly 10 as in FIGS. 2-5.

FIG. 7 is a fully assembled drawing of the bolt head subassembly 10 as in FIGS. 2-6.

FIG. 8 is a side view of the fully assembled bolt head subassembly as in FIGS. 2-7.

FIG. 9 is a side view of the fully assembled bolt head subassembly as in FIGS. 2-8.

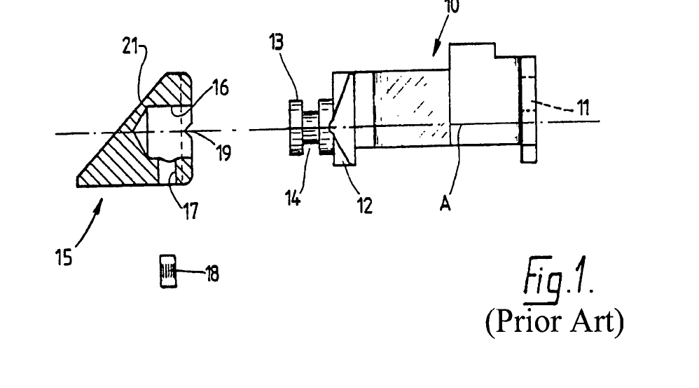

### DETAILED DESCRIPTION OF THE PREFERRED EMBODIMENTS

The present invention is a reversible latch bolt assembly for a mortise lock that includes a selector assembly built into the body to allow free withdrawal and rotation of the bolt head when necessary to reverse the bolt head, thereby allowing easy mounting in either a left-hand or right-hand door.

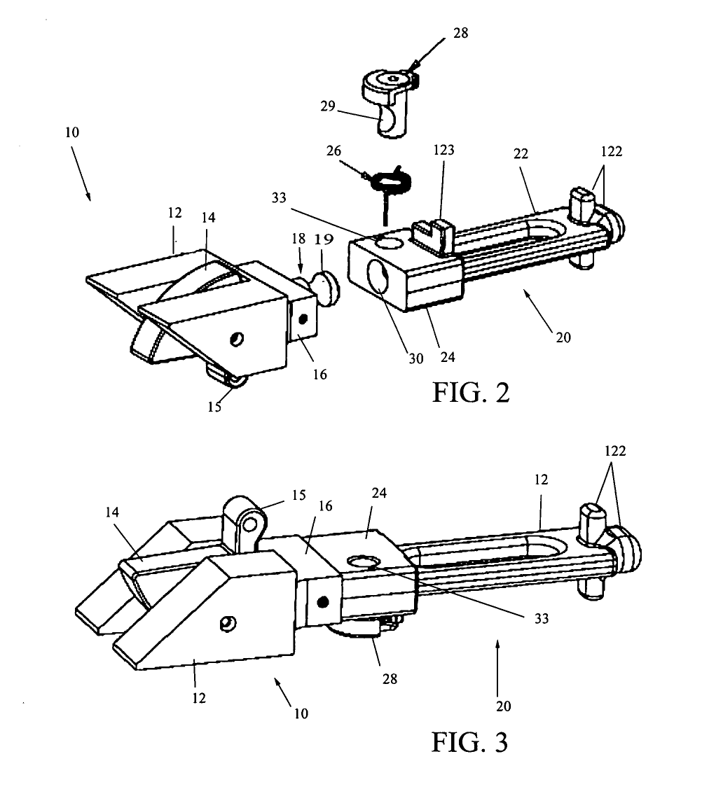

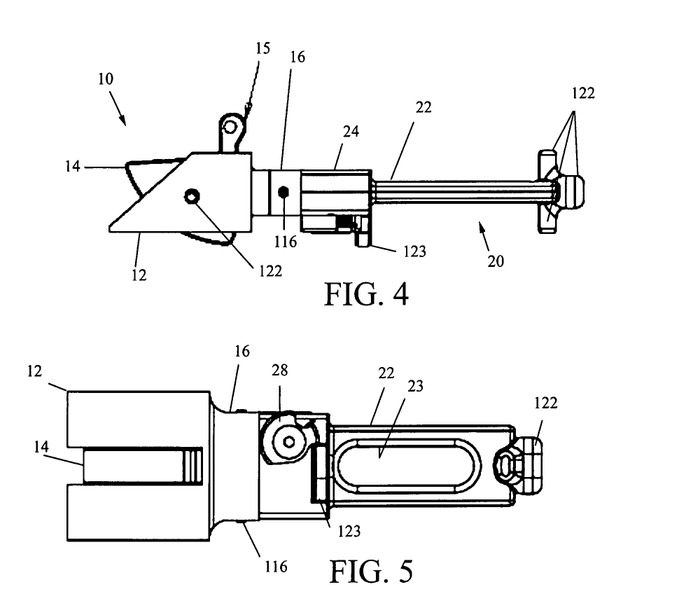

FIG. 2 is an exploded drawing, FIG. 3 is a fully assembled drawing, FIG. 4 is a top view, and FIG. 5 is a side view of the reversible latch bolt for mortise locks according to a preferred embodiment of the present invention. With combined reference to FIGS. 2-5, the latch bolt assembly generally comprises a bolt head subassembly 10 having a three-prong bolt head formed by a stationery two-prong yoke 12 with trigger-activated single-prong 14 pivotally mounted there between. A stem 18 is threaded into the rear 16 of the fixed two-prong yoke and the stem 18 is formed with an outwardly-protruding annular collar 19 of semi-circular contour. The bolt head subassembly 10 mates end-to-end with a body 20 designed for anchoring the reversible latch bolt assembly inside a door (not shown). Specifically, the stem 18 of the bolt head subassembly 10 is inserted distally into an aperture 30 in the body 20. A rotary selector assembly 28 is mounted in the body 20 orthogonal to aperture 30 and, when the stem 18 is inserted, selectively engages or disengages the collar 19 of the stem 18 to prevent or allow withdrawal thereof. The rotary selector assembly 28 is spring biased by a torsion spring 26 toward a normally locked position and can be rotated 90 degrees to an unlocked position by a hex key or the like. The selector assembly 28 allows free rotation of the entire bolt head subassembly 10 when necessary to reverse the bolt head, depending on whether the lock is mounted in a left-hand or right-hand door. Since the integral selector assembly 28 is key-operated from the latch body, tampering is nearly-impossible.

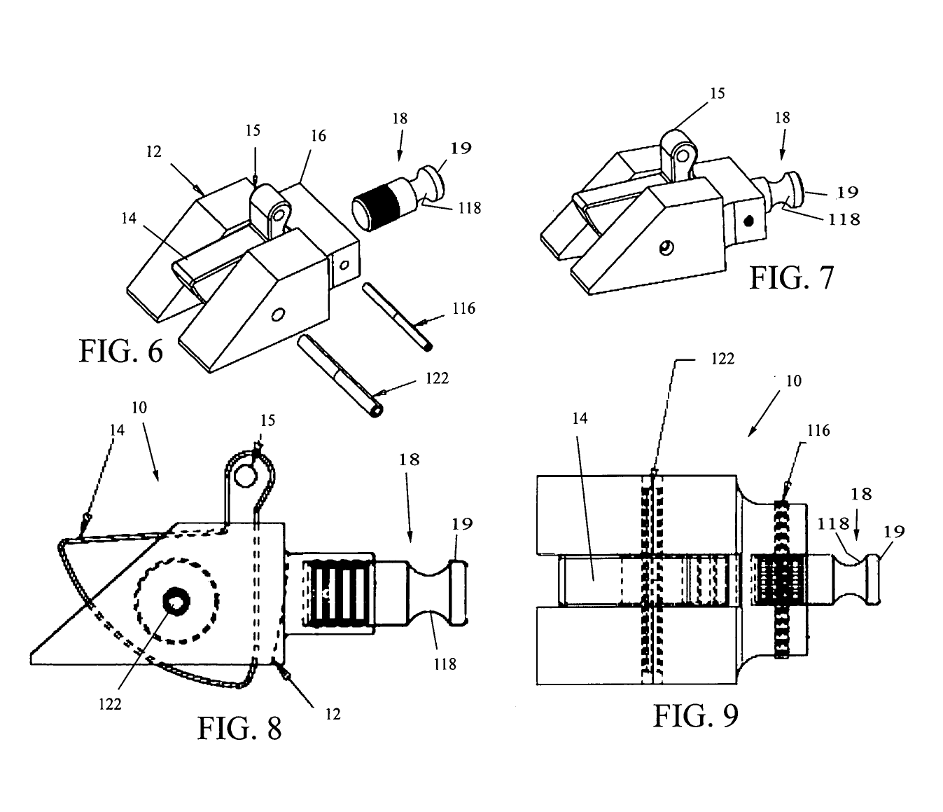

FIG. 6 is an exploded perspective drawing of the bolt head subassembly 10, FIG. 7 is a fully assembled drawing of the bolt head subassembly 10, FIG. 8 is a side view of the fully assembled bolt head subassembly, and FIG. 9 is a side view of the fully assembled bolt head subassembly. With combined reference to FIGS. 6-9, the bolt head subassembly 10 includes a stationery two-prong yoke 12 formed as a unitary component with opposing forwardly-protruding wedge-like prongs joined by a lateral shoulder 16. A pivoting third prong 14 rides there between, the third prong 14 being carried on a compression pin 122 inserted transversely through the yoke 12. The pivoting prong 14 likewise comprises a forwardly-protruding wedge-like prong and also an upwardly-protruding trigger 15 to initiate pivoting (by engagement with an external triggering mechanism). The stem 18 comprises a short machined ferrule with screw threads at one end for engaging a threaded aperture in the shoulder 16 of the fixed two-prong yoke 12, and dimensioned to protrude rearwardly therefrom approximately ½″. Another compression pin 116 may be inserted laterally into the shoulder 16 to prevent loosening of the stem 18. The protruding section of stem 18 is formed with a semi-circular channel 118 defining an annular collar 19 there around. The stem 18 is inserted into the aperture 30 of body 20 and is selectively captured therein by the rotary selector assembly 28 mounted in the body 20.

Referring back to FIGS. 2 and 3, the rotary selector assembly 28 comprises a keyed actuator with downwardly-protruding post. The keyed actuator includes a rotary head defined by a keyslot for insertion of a hex key or other tool. The downwardly-protruding post is inserted into an aperture 33 that is offset slightly to one side and orthogonally intersects the aperture 30 in body 20. The post of rotary selector assembly 28 is defined by an arcuate indentation 29 that generally conforms to the cylindrical stem 18. This way, when the rotary selector assembly 28 is turned to a first position wherein the arcuate indentation 29 faces the cylindrical stem 18, the stem can be extracted from the body 20 to free the entire bolt head subassembly 10 for withdrawal/reversal. On the other hand, when the rotary selector assembly 28 is turned to a second position wherein the arcuate indentation 29 faces away from the cylindrical stem 18, the post of rotary selector assembly 28 engages the collar 19 of stem 18 and locks the entire bolt head subassembly 10 to the body 20. The rotary selector assembly 28 is preferably key-actuated such as, for instance, by a hex key to prevent tampering. The body 20 is formed with an elongate section generally adapted to accommodate particular lock mechanism(s) and to anchor the mortise lock inside a door. Various anchoring features may be provided for this latter purpose including one or more anchoring flanges 122, 123 that protrude from body 20. In accordance with the present invention one of these anchoring flanges 123 serves a dual-purpose, also providing a position index for the rotary selector assembly 28. This is accomplished by forming the rotary head of the selector assembly 28 with a cutout that is indexed to the anchoring flange 123 to allow a one-quarter (90 degree) turn, thereby indexing the first position (arcuate indentation 29 faces the cylindrical stem 18 such that stem can be extracted from the body 20) and second position (arcuate indentation 29 faces away from the cylindrical stem 18 so that stem cannot be extracted from the body 20). In both positions the selector assembly 28 allows free rotation of the entire bolt head subassembly 10, and removal of the latch bolt assembly 10 when necessary to reverse the bolt head, depending on whether the lock is mounted in a left-hand or right-hand door. Absolutely no disassembly of any parts from the lock are required to reverse the latch bolt. Moreover, since the integral selector assembly 28 is key-operated from the latch body, tampering is nearly-impossible.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

We claim:

1. A reversible latch bolt assembly for a mortise lock, comprising:
a bolt head subassembly including a stem attached thereto and protruding outward to a distal tip defined by a channel;
a latch body for anchoring the reversible latch bolt assembly inside a door, said latch body including an aperture leading into said latch body for insertion of the stem of the bolt head subassembly, a channel orthogonal to said aperture and in communication therewith, and a selector assembly inserted into said channel;
whereby said selector assembly selectively locks the stem of said bolt head subassembly inside said aperture when rotated to a first position, and releases the stem of said bolt head subassembly from said aperture when rotated to a second position.

2. The reversible latch bolt assembly according to claim 1, wherein said channel comprises a radial channel.

3. The reversible latch bolt assembly according to claim 2, wherein said radial channel comprises a semi-cylindrical cross-section.

4. The reversible latch bolt assembly according to claim 1, wherein said bolt head is a three-prong bolt head.

5. The reversible latch bolt assembly according to claim 3, wherein said three-prong bolt head comprises a stationery two-prong yoke with pivoting intermediate prong.

6. The reversible latch bolt assembly according to claim 4, wherein said pivoting intermediate prong is trigger activated.

7. The reversible latch bolt assembly according to claim 1, wherein said rotary selector assembly is spring biased toward a normally locked position and can be rotated to an unlocked position.

8. A reversible latch bolt assembly for a mortise lock, comprising:
a bolt head subassembly including a stem having an annular channel;
a latch body for anchoring the reversible latch bolt assembly inside a door, said latch body including an aperture leading into said latch body for insertion of the stem and channel of the bolt head subassembly, and a selector assembly for selectively protruding a locking member into the channel of said bolt head subassembly;
whereby said selector assembly extends said locking member into the annular channel of said bolt head subassembly to selectively lock the stem of said bolt head subassembly inside said aperture, and retracts said locking member from the annular channel of said bolt head subassembly to selectively unlock the stem of said bolt head subassembly from inside said aperture.

9. The reversible latch bolt assembly according to claim 7, wherein said channel comprises a radial channel.

10. The reversible latch bolt assembly according to claim 8, wherein said radial channel comprises a semi-cylindrical cross-section.

11. The reversible latch bolt assembly according to claim 7, wherein said bolt head is a three-prong bolt head.

12. The reversible latch bolt assembly according to claim 10, wherein said three-prong bolt head comprises a stationery two-prong yoke with pivoting intermediate prong.

13. The reversible latch bolt assembly according to claim 11, wherein said pivoting intermediate prong is trigger activated.

14. The reversible latch bolt assembly according to claim 7, wherein said selector assembly is a rotary selector assembly.

15. The reversible latch bolt assembly according to claim 12, wherein said rotary selector assembly is spring biased toward a normally locked position and can be rotated to an unlocked position.

16. A reversible latch bolt assembly for a mortise lock, comprising:
a bolt head subassembly including a stem attached thereto and protruding outward to a distal collar;
a latch body for anchoring the reversible latch bolt assembly inside a door, said latch body including an aperture leading into said latch body for insertion of the stem;
a selector in communication with said aperture for selectively engaging and disengaging the collar of the stem of said bolt head subassembly inside said aperture.

17. The reversible latch bolt assembly according to claim 14, wherein said bolt head subassembly includes a stem attached thereto and protruding outward to a radial channel proximate a distal collar.

18. The reversible latch bolt assembly according to claim 15, wherein said radial channel comprises a semi-cylindrical cross-section.

19. The reversible latch bolt assembly according to claim 7, wherein said selector is inserted in a bore in communication with said aperture.

20. The reversible latch bolt assembly according to claim 17, wherein said selector is a rotary selector assembly that engages said stem by rotation.

21. The reversible latch bolt assembly according to claim 18, further comprising a spring for biasing said rotary selector toward a normally locked position and allowing rotation to an unlocked position.

22. A method of reversing a latch bolt assembly of a mortise lock of a type having a bolt head subassembly attached to a latch body via a pin inserted into an aperture in said latch body, comprising the steps of:
rotating a selector assembly on said latch body to extract a pin from said aperture, thereby freeing said latch body;
removing and reversing said bolt head subassembly.
